(19) United States
(12) Patent Application Publication
(10) Pub. No.: US 2025/0349843 A1
(43) Pub. Date: Nov. 13, 2025

(54) CATHODE ACTIVE MATERIAL

(71) Applicant: TOYOTA JIDOSHA KABUSHIKI KAISHA, Toyota-shi (JP)

(72) Inventor: Ryosuke OHSAWA, Okazaki-shi, (JP)

(73) Assignee: TOYOTA JIDOSHA KABUSHIKI KAISHA, Toyota-shi (JP)

(21) Appl. No.: 19/036,589

(22) Filed: Jan. 24, 2025

(30) Foreign Application Priority Data
May 13, 2024 (JP) 2024-077868

(51) Int. Cl. H01M 4/525; H01M 4/02

(52) U.S. Cl. CPC H01M 4/525; H01M 2004/021; H01M 2004/028

(57) ABSTRACT

A cathode active material includes a secondary particle. The secondary particle includes 3 to 20 crystallites. Each of the crystallites has a maximum Feret diameter of 1 μm or more. Either or both of the crystallite and the secondary particle have an open pore. The open pore has an opening diameter of 10 nm to 500 nm. The relation of “0.50≤L/D” is satisfied. “L” represents the path length of the open pore. “D” represents the maximum Feret diameter of the secondary particle.

### CROSS-REFERENCE TO RELATED APPLICATION

This application claims priority to Japanese Patent Application No. 2024-077868 filed on May 13, 2024, incorporated herein by reference in its entirety.

### BACKGROUND

### 1. Technical Field

The present disclosure relates to cathode active materials.

### 2. Description of Related Art

WO 2022/137360 discloses a lithium composite oxide sintered plate having specific ranges of porosities, average pore sizes, and interface lengths.

### SUMMARY

Conventionally, a cathode active material is synthesized by, for example, the following method. A precursor (such as a metal hydroxide) is synthesized. A mixture of the precursor and a lithium (Li) compound is heat-treated. The heat treatment is also referred to as “firing.” The firing causes Li to penetrate the precursor, so that a cathode active material can be synthesized.

The precursor is a secondary particle. The secondary particle includes a plurality of crystallites (primary particles). Particle growth of the crystallites also proceeds during the firing. The secondary particle becomes dense due to the particle growth of the crystallites. As a result, migration of Li ions is inhibited, and the reactive area may decrease. The smaller reactive area may lead to an increase in initial resistance.

An object of the present disclosure is to reduce initial resistance.

1. A cathode active material includes a secondary particle. The secondary particle includes 3 to 20 crystallites. Each of the crystallites has a maximum Feret diameter of 1 μm or more. Either or both of the crystallite and the secondary particle have an open pore. The open pore has an opening diameter of 10 nm to 500 nm. A relation of 0.50≤L/D is satisfied. “L” represents a path length of the open pore. “D” represents the maximum Feret diameter of the secondary particle.

The open pore may serve as an entrance and exit for Li ions to and from the secondary particle. In the present disclosure, the secondary particle has a long micropore. That is, the opening diameter of the open pore is 10 nm to 500 nm. Moreover, the ratio (L/D) of the path length of the open pore to the maximum Feret diameter of the secondary particle is 0.5 or more. This is expected to accelerate the reaction of the crystallites with Li ions inside the secondary particle. That is, initial resistance is expected to decrease because the reactive area increases.

2. The cathode active material according to the above “1” may include, for example, the following configuration. A relation of “0.50≤L/D≤1.3” is satisfied.

The upper limit of the ratio (L/D) may be any desired value. The upper limit may be, for example, 1.3.

3. The cathode active material according to the above “1” or “2” may include, for example, the following configuration. The open pore is open between the crystallites.

In the secondary particle, the open pore may be, for example, a space between the crystallites (primary particles). For example, as described in “4” below, the open pore may be formed in the crystallite itself. The open pore may include both a path that extends in the space between the crystallites and a path that extends in the crystallite.

4. The cathode active material according to any one of the above “1” to “3” may include, for example, the following configuration. The open pore is open to a surface of the crystallite.

5. The cathode active material according to any one of the above “1” to “4” may include, for example, the following configurations. A section of the secondary particle includes a central region. The central region is similar in shape to a contour of the secondary particle. The central region has the same geometric center as a contour of the secondary particle. The central region has a maximum Feret diameter of 0.5D. At least part of the open pore extends in the central region.

Since the open pore extends in the central region of the secondary particle, the initial resistance is expected to decrease.

An embodiment of the present disclosure (hereinafter also simply referred to as “present embodiment”) and an example of the present disclosure (hereinafter also simply referred to as “present example”) will be described below. However, the present embodiment and the present example are not intended to limit the technical scope of the present disclosure. The present embodiment and the present example are illustrative in all respects. The present embodiment and the present example are not restrictive. The technical scope of the present disclosure includes all modifications that fall within the meaning and scope equivalent to the claims. For example, it is originally planned to extract any desired configurations from the present embodiment and combine them as desired.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram showing a cathode active material according to the present embodiment;

FIG. 2 is a conceptual diagram showing a central region and a peripheral region in the present embodiment;

FIG. 3 is a schematic flow chart of a process for producing a cathode active material according to the present embodiment; and

FIG. 4 is a table showing experimental results.

### DETAILED DESCRIPTION OF EMBODIMENTS

### Terms and Phrases

Geometric terms should not be construed in a strict sense. Examples of the geometric terms include “parallel”, “vertical”, and “orthogonal”. For example, “parallel” may deviate slightly from “parallel” in a strict sense. For example, directions, angles, distances, and the like may be relatively displaced within a range in which substantially the same function is obtained. The geometric terms may include, for example, design-related, work-related, or manufacturing-related, tolerances, variations, and so forth. Dimensional relationships in each drawing may not match actual dimensional relationships. The dimensional relationships in the drawings may be changed to facilitate understanding by readers. For example, the length, width, thickness, etc. may be changed. Part of the configurations may be omitted.

Numerical ranges such as “m % to n %” include upper and lower limits unless otherwise specified. That is, “m % to n %” indicates a numerical range of “m % or more and n % or less”. In addition, “m % or more and n % or less” includes “more than m % and less than n %”. The terms “greater than or equal to” and “less than or equal to” are represented by an equal signed inequality sign “≤, ≥”. “Super” and “less than” are represented by inequality signs “<, >” that do not include equal signs.

All numerical values are modified by the term “approximately.” The term “approximately” can mean, for example, ±5%, ±3%, ±1%, and the like. All numerical values may be approximations that may vary depending on the application of the subject technology. All numerical values can be displayed with significant digits. The measured value may be an average value in a plurality of measurements unless otherwise specified. The number of measurements may be three or more, five or more, or 10 or more. In general, it is expected that the reliability of the average value improves as the number of measurements increases. The measured value can be rounded by rounding based on the number of significant digits. The measured value can include an error etc. associated with, for example, the detection limit of a measuring device.

For example, the expression “either or both of A and B” includes “A or B” and “A and B”. “Either or both of A and B” may also be referred to as “A and/or B.”

“Crystallite” refers to a solid particle having a boundary between particles that is the smallest unit of the particle and that is recognized as incapable of being further subdivided. “Secondary particle” refers to an aggregate of two or more crystallites. The crystallites forming the secondary particle may also be referred to as primary particles.

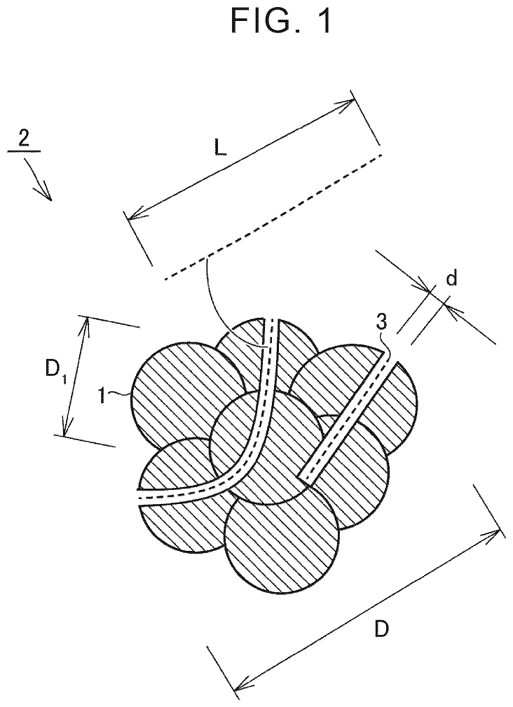

FIG. 1 is a conceptual diagram showing a cathode active material according to the present embodiment. The maximum Feret diameter of the crystallite 1 (D₁) is measured in the sectional SEM (Scanning Electron Microscope) image of the secondary particle 2. The “maximum Feret diameter (D)” of the secondary particle 2 is measured in the sectional SEM image of the secondary particle 2. The “opening diameter (d)” of the open pore 3 is measured in the sectional SEM image of the secondary particle 2. The “path length (L)” of the open pore 3 is measured in the sectional SEM image of the secondary particle 2. The observation magnification can be adjusted according to the particle size. The observation magnification may be, for example, about 1000 times. The sectional sample of the particles can be prepared by a conventionally known method. For example, CP (Cross Section Polisher), FIB (Focused Ion Beam) and the like may be used to prepare sectional samples. Various dimensions in the image are measured by image analysis software. For example, “ImageJ Fiji” or the like may be used. It should be noted that “ImageJ Fiji” is merely an example. Any image analysis software can be used as long as it has a function equivalent to “ImageJ Fiji”. For example, image analysis software attached to various SEM devices may be used.

The “maximum Feret diameter” refers to the distance between two most distant points on the contour of the grain in SEM images.

In the sectional SEM image of the secondary particle 2, the surface of the secondary particle 2 is observed. A pore that communicates with the outside air is an “open pore 3”. The diameter of the opening of the open pore 3 is “opening diameter (d)”. The “communication pore” indicates an open pore 3 having a plurality of openings. In the case of the communication hole, the arithmetic mean value of the plurality of opening diameters is regarded as the “opening diameter (d)”.

When a plurality of open pores 3 is formed in the secondary particle 2, the longest path length is regarded as “path length (L)”. If the open pore is branched or the open pores merge together, the sum of all path lengths is considered “path length (L)”.

The stoichiometric composition formula represents a representative example of a compound. The compound may have a non-stoichiometric composition. For example, “Al₂O₃” is not limited to compounds having a mass fraction (molar ratio) of “Al/O=2/3.” Unless otherwise noted, “Al₂O₃” refers to a compound containing Al and O at any molar ratio. For example, the compound may be doped with a trace element. Part of Al and O may be substituted with another element.

### Cathode Active Material

Hereinafter, the cathode active material of the present embodiment may also be simply referred to as “cathode active material”. The cathode active material is for a secondary battery. That is, the present disclosure also provides a “cathode including the cathode active material” and a “secondary battery including the cathode active material”. The secondary battery may be, for example, a liquid-based battery, a polymer battery, or an all-solid-state battery. The secondary battery may be, for example, a monopolar battery or a bipolar battery.

The cathode active material is a powder. D50 of the cathode active material may be, for example, 0.1 μm or more, 1 μm or more, 5 μm or more, or 10 μm or more. D50 may be, for example, 30 μm or less, 25 μm or less, 20 μm or less, 15 μm or less, or 10 μm or less. D50 can be measured, for example, by a laser diffraction method.

### Secondary Particle

As shown in FIG. 1, the cathode active material includes a secondary particle 2. The secondary particle 2 includes 3 to 20 crystallites 1. In the case where the number of crystallites 1 in the secondary particle 2 is less than three, there is a possibility that a desired initial resistance cannot be obtained. It is considered that the reactive area is small. When the number of crystallites 1 in the secondary particle 2 exceeds 20, for example, there is a possibility that the durability is lowered. The number of crystallites 1 included in the secondary particle 2 may be, for example, 15 or less, 10 or less, or 5 or less. The number of crystallites 1 included in the secondary particle 2 may be, for example, 5 or more, 10 or more, or 15 or more.

The maximum Feret diameter (D) of the secondary particle 2 may be, for example, 2 μm to 30 μm. The maximum Feret diameter (D) of the secondary particle 2 may be, for example, 3 μm or more, 6 μm or more, 9 μm or more, 12 μm or more, 15 μm or more, 18 μm or more, 21 μm or more, 24 μm or more, or 27 μm or more. The maximum Feret diameter (D) of the secondary particle 2 may be, for example, 27 μm or less, 24 μm or less, 21 μm or less, 18 μm or less, 15 μm or less, 12 μm or less, 9 μm or less, or 6 μm or less.

### Crystallite

The crystallite 1 has a maximum Feret diameter (D₁) of 1 μm or more. The maximum Feret diameter (D₁) of the crystallite 1 may be, for example, 1.5 μm or more, 2 um or more, or 2.5 μm or more. The maximum Feret diameter (D₁) of the crystallite 1 may be, for example, 3 μm or less, 2.5 μm or less, 2 μm or less, or 1.5 μm or less.

The crystallite 1 may have, for example, an aspect ratio of 1 to 2. The aspect ratio may be, for example, 1.8 or less, 1.6 or less, 1.4 or less, or 1.2 or less. The aspect ratio may be, for example, 1.2 or more, 1.4 or more, 1.6 or more, or 1.8 or more. “Aspect ratio” is the ratio of the major axis diameter to the minor axis diameter. The major axis diameter represents the maximum Feret diameter. The minor axis diameter represents the minimum Feret diameter.

### Open Pore

An open pore 3 is formed in either or both of the crystallite 1 and the secondary particle 2. The number of open pores 3 may be one or may be two or more. One open pore 3 may be branched. A plurality of open pores 3 may merge together. The number of open pores 3 included in one secondary particle 2 may be, for example, one or more, two or more, three or more, four or more, or five or more. The number of open pores 3 may be, for example, ten or less, nine or less, eight or less, seven or less, six or less, five or less, or four or less.

The open pore 3 may be open to, for example, the surface of the crystallite 1. The open pore 3 may pass through, for example, the crystallite 1. The open pore 3 may, for example, terminate in the crystallite 1. The open pore 3 may be open between, for example, the crystallites 1. The open pore 3 may pass through, for example, the secondary particle 2. The open pore 3 may, for example, terminate in the secondary particle 2. The open pore 3 may be, for example, a communication pore. The communication pore has a plurality of openings in the secondary particle 2 (or the crystallite 1). In the secondary particle 2, the open pore 3 may not extend in the crystallite 1. For example, the open pore 3 may be a space between the crystallites 1. When a plurality of open pores 3 is formed in one secondary particle 2, both an open pore 3 that extends in the crystallite 1 and an open pore 3 that is a space between the crystallites 1 may be formed. One open pore 3 may include both a path passing through the crystallite 1 and a path extending in a space between the crystallites 1.

The open pore 3 has an opening diameter (d). The opening diameter (d) is 10 nm to 500 nm. If the opening diameter (d) is less than 10 nm, the desired initial resistance may not be obtained. When the opening diameter (d) exceeds 500 nm, for example, cracking starting from the open pore 3 may occur in the secondary particle 2. The opening diameter (d) may be, for example, 25 nm or more, 400 nm or more, 50 nm or more, 75 nm or more, 100 nm or more, 150 nm or more, 200 nm or more, 250 nm or more, 300 nm or more, 350 nm or more, or 450 nm or more. The opening diameter (d) may be, for example, 450 nm or less, 400 nm or less, 350 nm or less, 300 nm or less, 250 nm or less, 200 nm or less, 150 nm or less, 100 nm or less, 75 nm or less, 50 nm or less, or 25 nm or less.

The open pore 3 has a path length (L). The ratio (L/D) of the path length (L) to the maximum Feret diameter (D) of the secondary particle 2 is 0.50 or more. When the specific (L/D) is 0.50 or more, the initial resistance is expected to be reduced. L/D may be, for example, 0.72 or more, 1.1 or more, or 1.3 or more. L/D may be, for example, 5 or less, 4 or less, 3 or less, 2 or less, 1.5 or less, 1.3 or less, 1.1 or less, or 0.72 or less.

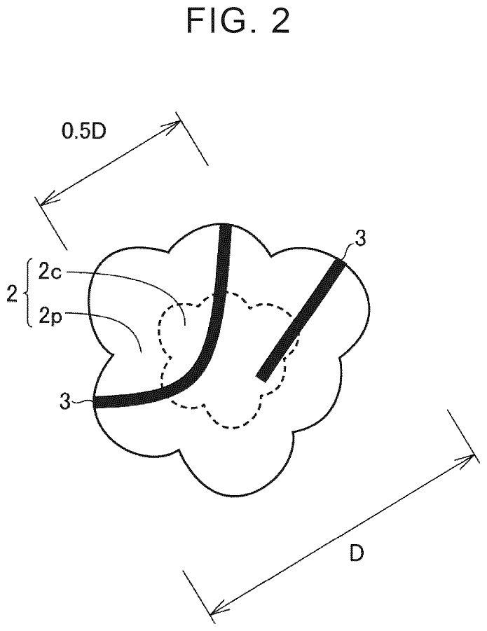

FIG. 2 is a conceptual diagram illustrating a central region and a peripheral region in the present embodiment. The section of the secondary particle 2 includes a central region 2c and a peripheral region 2p. The central region 2c is similar in shape to the contour of the secondary particle 2. The central region 2c has the same geometric center as the contour of the secondary particle 2. The maximum Feret diameter of the central region 2c is 0.5D. The section of the secondary particle 2 other than the central region 2c is the peripheral region 2p. The peripheral region 2p surrounds the central region 2c.

For example, the open pore 3 may extend toward the central region 2c. For example, the open pore 3 may extend toward the geometric center of the secondary particle 2. For example, at least part of the open pore 3 may extend in the central region 2c. For example, the open pore 3 may pass through the central region 2c. As the open pore 3 extends in the central region 2c of the secondary particle 2, the initial resistivity may decrease. The open pore 3 may, for example, terminate in the peripheral region 2p. The open pore 3 may, for example, terminate in the peripheral region 2p after passing through the central region 2c. The maximum Feret diameter of the central region 2c may be, for example, 0.4D, 0.3D, 0.2D, or 0.1D. As the maximum Feret diameter of the central region 2c is set to be smaller, the central region 2c may be limited to the grain center. The closer the open pore 3 passes near the particle center, the lower the initial resistance may be.

The open pore 3 may extend linearly, for example. The open pore 3 may extend, for example, in a curved manner. The open pore 3 extending in a curved manner may also reduce the initial resistance. The open pore 3 may have, for example, a linearity greater than 1.5. The linearity may be, for example, 1.6 or more, 1.8 or more, 2 or more, 2.2 or more, or 2.4 or more. The linearity may be, for example, 5 or less, 4 or less, 3 or less, or 2 or less.

The “linearity” of the open pore 3 is obtained by the following equation. The closer the linearity is to 1, the more the open pore 3 is considered to be linear. In other words, it is considered that the open pore 3 is curved as the degree of linearity moves away from 1.

$$S = {L}_{0} / {L}_{1}$$

S: Linearity
L₀: Path length of open pore 3 in sectional SEM image
L₁: linear distance between openings of open pore 3 in sectional SEM image (linear distance between inlet and outlet)

### Chemical Composition

The crystallite 1 may include, for example, a lithium metal composite oxide. The crystallite 1 may be made of, for example, a lithium metal composite oxide. The lithium metal composite oxide may have, for example, a layered rock salt structure. The layered rock salt structure is also referred to as “α-NaFeO₂-type structure.” The space group of the stratified rock salt type structure is “R-3m”. The crystallization can be determined by the powder XRD (X-ray diffraction) method.

The lithium metal composite oxide may have any chemical composition. The lithium metal composite oxide may have, for example, a composition represented by the following general formula.

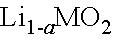

In the formula, “−0.5≤a≤0.5” is satisfied. “M” includes at least one selected from the group consisting of Ni, Co, Mn, and Al.

The lithium metal composite oxide may be, for example, a lithium nickel composite oxide. The composition of the lithium nickel composite oxide may be represented by, for example, the following general formula. Compounds of the general formula below may also be referred to as “NCM”.

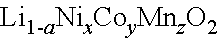

In the formula, “−0.5≤a≤0.5”, “0<x<1”, “0<y<1”, “0<z<1”, and “x+y+z=1” are satisfied. For example, relations such as “0.5≤x<1”, “0<y≤0.25”, and “0<z≤0.25” may be satisfied.

The composition of the lithium nickel composite oxide may be represented by, for example, the following general formula. Compounds represented by the formulae below may also be referred to as “NCA”.

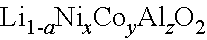

In the formula, “−0.5≤a≤0.5”, “0<x<1”, “0<y<1”, “0<z<1”, and “x+y+z=1” are satisfied. For example, relations such as “0.5≤x<1”, “0<y≤0.25”, and “0<z≤0.25” may be satisfied.

A dopant may be added to the lithium metal composite oxide. The dopant may be diffused throughout the particle or may be locally distributed. For example, dopants may be unevenly distributed on the particle surface. The dopant may be a substituted solid solution atom or an infiltrated solid solution atom. The amount of the dopant added (mass fraction to the entire cathode active material) may be, for example, 0.01% to 5%, 0.1% to 3%, or 0.1% to 1%. One or more dopants may be added. Two or more dopants may form a complex. The dopant may include, for example, at least one selected from the group consisting of B, C, N, halogens, Si, Na, Mg, Al, Mn, Co, Cr, Sc, Ti, V, Cu, Zn, Ga, Ge, Se, Sr, Y, Zr, Nb, Mo, In, Pb, Bi, Sb, Sn, W, La, Ce, Pr, Nd, Pm, Sm, Eu, Gd, Tb, Dy, Ho, Er, Tm, Yb, Lu, and actinoids.

### Method for Manufacturing Cathode Active Material

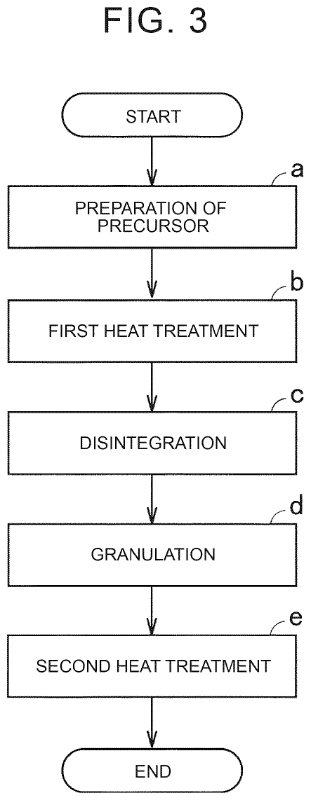

FIG. 3 is a schematic flowchart of a method for producing a cathode active material according to the present embodiment. Hereinafter, a method for manufacturing a cathode active material according to the present embodiment may be simply referred to as the “manufacturing method.” The process includes “(a) preparation of precursor,” “(b) first heat treatment,” “(c) disintegration,” “(d) granulation,” and “(e) second heat treatment.”

### (a) Preparation of Precursor

The manufacturing method includes preparing a precursor. The precursor may include, for example, a metal hydroxide. The metal hydroxide may be synthesized, for example, by a coprecipitation method or the like. For example, a sulfate salt may be provided. The sulfate may include, for example, at least one selected from the group consisting of NiSO₄, CoSO₄, MnSO₄, and Al₂(SO₄)₃. By dissolving the sulfate in water, a raw material solution is prepared. The concentration of the raw material solution may be, for example, 10% to 50% by mass fraction. By dropping the raw material solution into the alkaline aqueous solution, precipitation of the metal hydroxide can be generated. For example, the precipitate (metal hydroxide) may be recovered by filtration. After recovery, the metal hydroxide may be washed with water. After washing with water, the metal hydroxide may be dried.

The precursor is mixed with an Li compound. For example, grinding and mixing may be performed in a mortar or the like. The Li compound refers to a compound containing Li. The Li compound may include, for example, at least one selected from the group consisting of LiOH and Li₂CO₃. The Li compound is an Li source of the lithium metal composite oxide. The mass fraction of Li to the metal hydroxide may be, for example, 0.5 or more, 0.75 or more, 1 or more, 1.1 or more, or 1.25 or more. The ratio may be, for example, 1.5 or less, 1.25 or less, 1.1 or less, 1 or less, or 0.75 or less.

### (b) First Heat Treatment

The manufacturing method includes subjecting the mixture of the precursor and the Li compound to a first heat treatment. In the manufacturing method, any heat treatment device or firing furnace may be used. For example, muffle furnaces, electric furnaces, etc. may be used. The first heat treatment may be performed under an oxygen atmosphere, for example. The same applies to the second heat treatment described later.

The temperature of the first heat treatment may be, for example, 1000° C. to 1300° C. The temperature of the first heat treatment may be, for example, 1100° C. or higher, or 1200° C. or higher. The temperature of the first heat treatment may be, for example, 1200° C. or less, or 1100° C. or less. The time of the first heat treatment may be, for example, 2 hours to 8 hours. The time of the first heat treatment may be, for example, 3 hours or more, 4 hours or more, or 5 hours or more. The time of the first heat treatment may be, for example, 7 hours or less, 6 hours or less, or 5 hours or less.

### (c) Disintegration

The manufacturing method includes disintegrating the material after the first heat treatment. For example, disintegration may be performed by a crusher. Any grinder (e.g., jet mill, etc.) may be used.

### (d) Granulation

The manufacturing method includes forming the secondary particle 2 by granulating the material after disintegration. By undergoing disintegration and granulation, a long open pore 3 can be formed in the secondary particle 2. The open pore 3 may be formed in a curved manner. Granulation may be performed by, for example, a spray dryer. That is, the secondary particle 2 may be formed by spray-drying the slurry. For example, the ratio (L/D) may be adjusted according to the solids content of the slurry. The solid content concentration of the slurry may be, for example, 5% or more, 10% or more, 20% or more, or 30% or more in terms of mass fraction. The solids concentration of the slurry may be, for example, less than 40%, 35% or less, 30% or less, 20% or less, or 10% or less. The dispersion medium of the slurry may include, for example, isopropyl alcohol (IPA).

### (e) Second Heat Treatment

The manufacturing method includes subjecting the secondary particle 2 after granulation to a second heat treatment. The second heat treatment may be performed at a lower temperature than the first heat treatment. The temperature difference between the second heat treatment and the first heat treatment may be, for example, 600° C. or higher, 700° C. or higher, 800° C. or higher, or 900° C. or higher. The temperature difference between the second heat treatment and the first heat treatment may be, for example, 900° C. or less, 800° C. or less, 700° C. or less, or 600° C. or less.

The temperature of the second heat treatment may be, for example, 200° C. or higher, 300° C. or higher, or 400° C. or higher. The temperature of the second heat treatment may be, for example, 600° C. or less, 500° C. or less, or 400° C. or less. The time of the second heat treatment may be, for example, 2 hours to 8 hours. The time of the second heat treatment may be, for example, 3 hours or more, 4 hours or more, or 5 hours or more. The time of the second heat treatment may be, for example, 7 hours or less, 6 hours or less, or 5 hours or less. The total time of the second heat treatment and the first heat treatment may be, for example, 8 hours or more, 9 hours or more, or 10 hours or more. The total time of the second heat treatment and the first heat treatment may be, for example, 12 hours or less, 11 hours or less, or 10 hours or less.

### Others

As described above, the secondary particle 2 having the open pore 3 can be synthesized. In another embodiment, for example, the open pore 3 may be formed by pushing the needle-shaped jig into the secondary particle 2. According to the method, the open pore 3 that is open to the surface of the crystallite 1 can also be formed. According to the method, the open pore 3 that extends linearly can also be formed.

### Production of Cathode Active Material

### No. 1

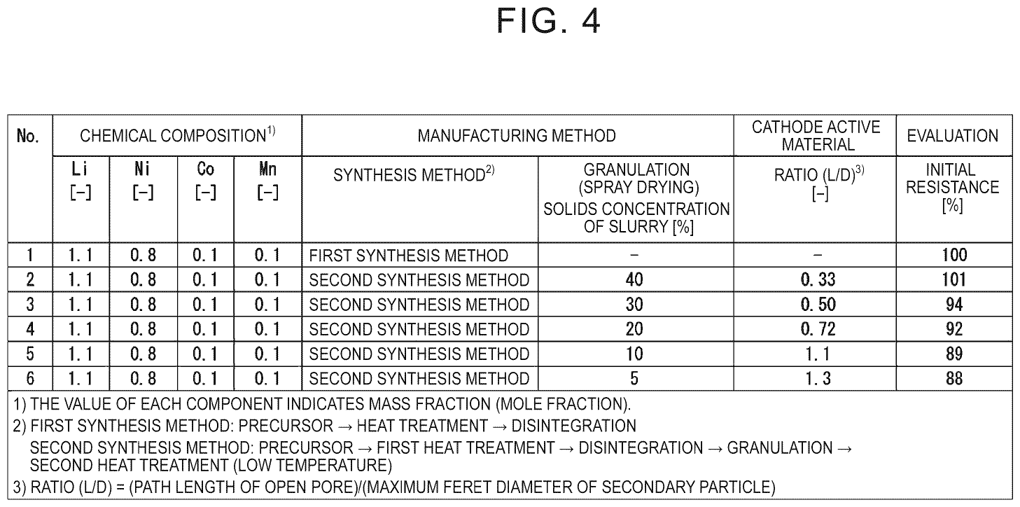

FIG. 4 is a table showing experimental results. In No. 1, a cathode active material was produced by the first synthetic method. A raw material solution was produced by dissolving NiSO₄, CoSO₄, and MnSO₄ in ion-exchange water. In the raw material solution, the molar ratio of Ni, Co, and Mn was “Ni/Co/Mn=8/1/1.” The concentration of the raw material solution was 30% by mass fraction.

Ammonia water was placed in the reaction vessel. The inside of the reaction vessel was replaced with nitrogen while the ammonia water was stirred with the stirrer. Further, the reaction solution was formed by charging NaOH into the reaction vessel.

Precipitation (metallic hydroxide) was formed by dropping the raw material solution and ammonia-water into the reaction liquid so that the reaction liquid maintained a certain pH. The reaction solution was filtered to recover the metal hydroxide. A dispersion was formed by dispersing the metal hydroxide in ion-exchanged water. The dispersion was sufficiently stirred by the spatula. That is, the metal hydroxide was washed with water. After washing with water, the dispersion was filtered to recover the metal hydroxide. The metal hydroxide was dried at 120° C. for 16 hours to form a precursor.

In a mortar, the precursor and the Li compound (Li₂CO₃) were mixed to produce a mixture.

In the muffle furnace, the mixture was subjected to a heat treatment to obtain a calcined product. Conditions of the heat treatment were as follows.
Atmosphere: Oxygen atmosphere
Temperature: 800 to 1100° C.
Time: 10 hours

The calcined product was disintegrated by a jet mill. As described above, the cathode active material (secondary particle) was produced.

### No. 2

In Nos. 2 to 6, the cathode active material was produced by the second synthetic method. A precursor was prepared as in No. 1. The precursor and the Li compound (Li₂CO₃) were mixed to produce a mixture.

In a muffle furnace, the mixture was subjected to a first heat treatment to obtain a calcined product. Conditions of the first heat treatment were as follows.
Atmosphere: Oxygen atmosphere
Temperature: 1000° C. to 1300° C.
Time: 5 hours

By the jet mill, by the fired product is disintegration, the disintegrated product was obtained. A slurry was formed by distributing the disintegrated product in the dispersion medium. The solids concentration of the slurry was 40%. The slurry was spray dried by a spray dryer to obtain a secondary particle. The operating conditions of the spray dryer were as follows.
Spray dryer: MDL-050B, manufactured by GF
Drying temperature: (inlet) 200° C., (outlet) 100° C.
Nozzle pressure: 0.5 MPa
Flow rate: 40 L/min

In the muffle furnace, the secondary particle was subjected to a second heat treatment to produce a cathode active material. Conditions of the second heat treatment were as follows.
Atmosphere: Oxygen atmosphere
Temperature: 400° C.
Time: 5 hours
Nos. 3 to 6

As shown in FIG. 4, a cathode active material was produced in the same manner as in No. 2, except that the solid content of the slurry was changed.

### Evaluation

A cylindrical lithium-ion secondary battery (evaluation cell) was manufactured. The initial resistance of the evaluation cell was measured. The structure of the evaluation cell is as follows.
Power generation element: wound type
Cathode: cathode active material/AB/PVDF=88/10/2 (mass ratio)
Anode: anode active material (natural graphite), CMC, SBR
Electrolyte: LiPF₆ (1 mol/L), EC/DMC/EMC=3/4/3 (volume ratio)

The cathode and the anode were manufactured by coating a slurry on the surface of a substrate (metal foil). As a coating apparatus, a film applicator (with a film thickness adjustment function) manufactured by All Good Co. was used. After coating the slurry, the coating was dried at 80° C. for 5 minutes.

### Result

The initial resistance in FIG. 4 is a relative value when the initial resistance of No. 1 is regarded as 100%. When the specific (L/D) is 0.50 or more, the initial-resistance tends to decrease. As L/D increases, the initial-resistance tends to decrease.

What is claimed is:

1. A cathode active material comprising a secondary particle, wherein:
the secondary particle includes 3 to 20 crystallites;
each of the crystallites has a maximum Feret diameter of 1 μm or more;
either or both of the crystallite and the secondary particle have an open pore;
the open pore has an opening diameter of 10 nm to 500 nm; and
a relation of 0.50≤L/D is satisfied,
where the L represents a path length of the open pore, and
the D represents the maximum Feret diameter of the secondary particle.

2. The cathode active material according to claim 1, wherein a relation of 0.50≤L/D≤1.3 is satisfied.

3. The cathode active material according to claim 1, wherein the open pore is open between the crystallites.

4. The cathode active material according to claim 1, wherein the open pore is open to a surface of the crystallite.

5. The cathode active material according to claim 1, wherein:
a section of the secondary particle includes a central region;
the central region is similar in shape to a contour of the secondary particle;
the central region has the same geometric center as a contour of the secondary particle;
the central region has a maximum Feret diameter of 0.5D; and
at least part of the open pore extends in the central region.
